(19) United States
(12) Patent Application Publication
(10) Pub. No.: US 2016/0239809 A1
(43) Pub. Date: Aug. 18, 2016

(54) SYSTEMS AND METHODS FOR IMPLEMENTING MINIMALLY OBSTRUCTIVE MULTIFUNCTIONAL HORIZONTALLY ORIENTED CALENDAR

(71) Applicant: Limited Liability Company Mail.Ru, Moscow (RU)

(72) Inventor: YURY VETROV, Moscow (RU)

(21) Appl. No.: 15/000,015

(22) Filed: Jan. 18, 2016

Related U.S. Application Data
(63) Continuation of application No. PCT/RU2013/000622, filed on Jul. 19, 2013.

(51) Int. Cl. G06Q 10/10; G06F 3/0486; G06F 3/0354; G06F 3/0484; G06F 3/0482; G06F 3/0481; G06T 11/00

(52) U.S. Cl. CPC G06Q 10/1093; G06F 3/04812; G06F 3/0486; G06T 11/001; G06F 3/04842; G06F 3/0482; G06F 3/03543; G06F 2203/04803

(57) ABSTRACT

Method involves generating a graphical user interface on the display device, the graphical user interface including a calendar portion, the calendar portion including a plurality of calendar date elements, wherein the plurality of calendar date elements are horizontally arranged on the display device and wherein at least some of the calendar date elements comprise a user availability indicator indicating an availability of a user during a corresponding day; receiving information on a user interaction event in connection with the calendar portion of the user interface; if the received information indicates that the user interaction event is a cursor hover event performed in connection with a first calendar date element of the plurality of calendar date elements, displaying information regarding the first calendar date element; and if the received information indicates that the user interaction event is a drag-and-drop event performed in connection with a second calendar date element of the plurality of calendar date elements and a schedule item, placing the schedule item on the user's schedule during a date corresponding to the second calendar date element.

### BACKGROUND OF THE INVENTION

1. Technical Field

The disclosed embodiments relate in general to graphical user interfaces of electronic computing devices and, more specifically, to systems and methods for providing minimally obstructive multifunctional horizontally oriented calendar.

2. Description of the Related Art

Conventional calendar graphical user interfaces suffer from a number of drawbacks. The most important of them is the need to open a separate calendar window or a web page, which unavoidably interferes with the current task performed by the user. While there exist calendar user interfaces that display dates in one-line arrangement, which is less obstructive on the computer display, the user interaction with these calendar interfaces is limited to date navigation. For example, the users are not allowed to drop items onto such calendars to create new calendar events and cannot view scheduled calendar events by any other means than clicking on the specific date, which opens a new calendar window with calendar information regarding that specific date. The users are also not able to judge how busy they are on the specific date by simply looking at the conventional horizontal calendars without having to click on each date separately.

Therefore, new and improved techniques for implementing graphical user interfaces incorporating minimally obstructive multifunctional horizontally oriented calendars providing rich user interaction capabilities.

### SUMMARY OF THE INVENTION

The embodiments described herein are directed to methods and systems that substantially obviate one or more of the above and other problems associated with conventional techniques for implementing graphical user interfaces for calendars.

In accordance with one aspect of the inventive concepts described herein, there is provided a computer-implemented method for generating a graphical user interface, the method being performed in connection with a computerized system comprising a processor, a memory and a display device, the method involving: generating a graphical user interface on the display device, the graphical user interface comprising a calendar portion, the calendar portion comprising a plurality of calendar date elements, wherein the plurality of calendar date elements are horizontally arranged on the display device and wherein at least some of the calendar date elements comprise a user availability indicator indicating an availability of a user during a corresponding day; receiving information on a user interaction event in connection with the calendar portion of the user interface; if the received information indicates that the user interaction event is a cursor hover event performed in connection with a first calendar date element of the plurality of calendar date elements, displaying information regarding the first calendar date element; and if the received information indicates that the user interaction event is a drag-and-drop event performed in connection with a second calendar date element of the plurality of calendar date elements and a schedule item, placing the schedule item on the user's schedule during a date corresponding to the second calendar date element.

In one or more embodiments, the information regarding the first calendar date element is displayed is a pop-up window.

In one or more embodiments, the user availability indicator is color-coded based on the availability of the user during the corresponding day.

In one or more embodiments, the user availability indicator is color-coded with a color selected from a group consisting of: green, yellow and red colors.

In one or more embodiments, the calendar portion further comprises at least one date navigational element and wherein upon user's interaction with the at least one date navigational element, a second plurality of calendar date element is displayed.

In one or more embodiments, the calendar portion is positioned at the bottom of the graphical user interface.

In one or more embodiments, if the received information indicates that the user interaction event is a mouse click event performed in connection with a third calendar date element of the plurality of calendar date elements, displaying information regarding the third calendar date element in a main window of the graphical user interface.

In accordance with another aspect of the inventive concepts described herein, there is provided a non-transitory computer-readable medium embodying a set of computer-readable instructions, which, when executed in connection with a computerized system comprising a processor, a memory and a display device, cause the computerized system to perform a method for generating a graphical user interface, the method involving: generating a graphical user interface on the display device, the graphical user interface comprising a calendar portion, the calendar portion comprising a plurality of calendar date elements, wherein the plurality of calendar date elements are horizontally arranged on the display device and wherein at least some of the calendar date elements comprise a user availability indicator indicating an availability of a user during a corresponding day; receiving information on a user interaction event in connection with the calendar portion of the user interface; if the received information indicates that the user interaction event is a cursor hover event performed in connection with a first calendar date element of the plurality of calendar date elements, displaying information regarding the first calendar date element; and if the received information indicates that the user interaction event is a drag-and-drop event performed in connection with a second calendar date element of the plurality of calendar date elements and a schedule item, placing the schedule item on the user's schedule during a date corresponding to the second calendar date element.

In one or more embodiments, the information regarding the first calendar date element is displayed is a pop-up window.

In one or more embodiments, the user availability indicator is color-coded based on the availability of the user during the corresponding day.

In one or more embodiments, the user availability indicator is color-coded with a color selected from a group consisting of: green, yellow and red colors.

In one or more embodiments, the calendar portion further comprises at least one date navigational element and wherein upon user's interaction with the at least one date navigational element, a second plurality of calendar date element is displayed.

In one or more embodiments, the calendar portion is positioned at the bottom of the graphical user interface.

In one or more embodiments, if the received information indicates that the user interaction event is a mouse click event performed in connection with a third calendar date element of the plurality of calendar date elements, displaying information regarding the third calendar date element in a main window of the graphical user interface.

In accordance with yet another aspect of the inventive concepts described herein, there is provided a computerized system comprising a processor, a memory and a display device, the memory storing a set of computer-readable instructions, which, when executed by the processor cause the computerized system to perform a method for generating a graphical user interface, the method involving: generating a graphical user interface on the display device, the graphical user interface comprising a calendar portion, the calendar portion comprising a plurality of calendar date elements, wherein the plurality of calendar date elements are horizontally arranged on the display device and wherein at least some of the calendar date elements comprise a user availability indicator indicating an availability of a user during a corresponding day; receiving information on a user interaction event in connection with the calendar portion of the user interface; if the received information indicates that the user interaction event is a cursor hover event performed in connection with a first calendar date element of the plurality of calendar date elements, displaying information regarding the first calendar date element; and if the received information indicates that the user interaction event is a drag-and-drop event performed in connection with a second calendar date element of the plurality of calendar date elements and a schedule item, placing the schedule item on the user's schedule during a date corresponding to the second calendar date element.

In one or more embodiments, the information regarding the first calendar date element is displayed is a pop-up window.

In one or more embodiments, the user availability indicator is color-coded based on the availability of the user during the corresponding day.

In one or more embodiments, the user availability indicator is color-coded with a color selected from a group consisting of: green, yellow and red colors.

In one or more embodiments, the calendar portion further comprises at least one date navigational element and wherein upon user's interaction with the at least one date navigational element, a second plurality of calendar date element is displayed.

In one or more embodiments, the calendar portion is positioned at the bottom of the graphical user interface.

In one or more embodiments, if the received information indicates that the user interaction event is a mouse click event performed in connection with a third calendar date element of the plurality of calendar date elements, displaying information regarding the third calendar date element in a main window of the graphical user interface.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary embodiment of a user interface incorporating a calendar portion, generated by one or more embodiments of a computerized user interface generation method described herein.

FIG. 2 illustrates an exemplary operating sequence of an embodiment of the application for generating the novel graphical user interface incorporating a calendar.

FIG. 3 is a block diagram that illustrates an embodiment of a computer system upon which an embodiment of the inventive functionality may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

In accordance with one or more embodiments described herein, there is provided a computerized system and an associated computer-implemented method for implementing graphical user interfaces incorporating minimally obstructive multifunctional horizontally oriented calendars providing rich user interaction capabilities. In various implementations, the graphical user interfaces described herein may be implemented as web-based graphical user interfaces generated using HTML code, JAVA scripts or any other appropriate mechanisms. In an alternative implementation, similar functionality may be implemented in a stand-alone application executing on a computing device, such as a smartphone or a tablet computer.

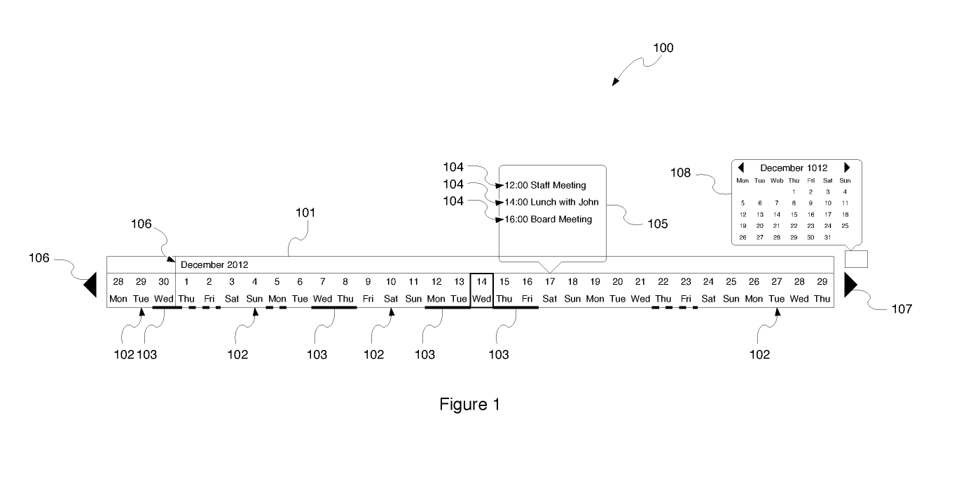

FIG. 1 illustrates an exemplary embodiment of a user interface 100 incorporating a calendar portion 101, generated by one or more embodiments of a computerized user interface generation method described herein. In one embodiment, the calendar portion 101 is displayed at the bottom of the graphical user interface 100. The calendar portion 101 includes a plurality of horizontally arranged date elements 102, each representing a different calendar date. As it would be appreciated by those of skill in the art, because the date elements 102 of the calendar portion 101 are horizontally arranged, they occupy a very small (stripe-shaped) portion of the user interface without creating an excessive obstruction for other displayed content. In one or more embodiments, the aforesaid date elements are sequentially arranged left-to-right. In one or more embodiments, the dates of the current month and two additional weeks are displayed by default to the user.

The date elements may be grouped by week or month with graphical divider elements 106 shown to divide different weeks or different months of the year. In one or more embodiments, each date element is user-interactive. When the user hovers a mouse cursor over a particular date element, or, in case of a touchscreen device touches the date element with his finger, the user interface generation program receives this user interaction event and, in response, displays to the user certain information related to the affected date element and/or performs other appropriate actions. In one or more embodiments, the information related to the affected date is displayed to the user in a separate window 105, which is generated in the vicinity of the date element 102 upon detection of the user interaction event. In displayed information may include all the events 104 scheduled for the user for that date. In one or more embodiments, the system is configured to display all information about each scheduled event without truncation. In the same or different embodiments, the system may display information about availability of the user on that date. When the user moves the cursor away from the date element, the aforesaid information window 105 may automatically close. In another embodiment, the window 105 may automatically close after passage of a time interval of a predetermined duration, such as 5 seconds. As it would be appreciated by those of ordinary skill in the art, by simply moving the cursor over the date element 102, the user may view the day's schedule without having to open a new calendar window and without interrupting user's current task.

In one or more embodiment, there is displayed a user availability indicator 103, which may be implemented in a form of a thin color-coded bar displayed in the bottom part of the corresponding date element 102. In one or more embodiments, the color of the user availability indicator represents the user's general availability during the respective date. For example, green availability indicator may indicate that the user's schedule is generally open. Yellow availability indicator indicates that the user may have limited availability during the respective date. Finally, red availability indicator indicates that the user is not available on the particular date. The color of the availability indicator may be determined by the user interface generation application by comparing number and/or duration of user's availability periods during the day with a predetermined set of thresholds. In an alternative embodiment, the number or duration of the user's scheduled events during the day may be compared with a predetermined set of thresholds. Each threshold would corresponds a predetermine color code. In one embodiment, red color of the availability indicator indicates that more than 65% of user's available time during the day is occupied with tasks. Yellow color of the indicator may indicate that more than 35% but less than 65% of user's available time during the day is occupied with tasks. Finally, green indicator shows that less than 35% of user's available time during the day is occupied. The absence of color-coded availability indicator indicates that the corresponding day is entirely open.

As it would be appreciated by those of skill I the art, using the colored availability indicator the user may quickly get an idea about availability during a particular day without having to open the entire schedule for that day and without having to interrupt user's current task.

In one or more embodiments, the user may drag and drop various schedule items on specific displayed date elements. The graphical user interface generation application receives information on the aforesaid drop event as well as the dropped schedule object from the touchscreen interface or other module(s) of the computing system and places the dropped schedule item on the calendar of the day corresponding to the targeted date element. Thus, the user may use the described calendar graphical user interface to schedule events without opening a new calendar window and without interrupting user's current task. For example, the user may re-schedule a calendar task by simply dragging it from one calendar date element 102 and dropping it onto another date element 102.

In one or more embodiments, the calendar graphical user interface may additionally incorporate one or more date navigational elements 106, 107 and/or 108. These elements enable the user to quickly move to a view displaying different dates, weeks or months of the year on the calendar. For example, the navigation element 108 may be displayed in a form of a mini-calendar, which may be conveniently used for date navigation. When the user clicks on navigational elements 106 or 107, the horizontal calendar moves to the left or right and additional date elements 102 appear. Finally, when the user clicks on a specific date element, the graphical user interface generation program may be configured to display the information on the selected day in the main window and highlight or otherwise mark the selected date element.

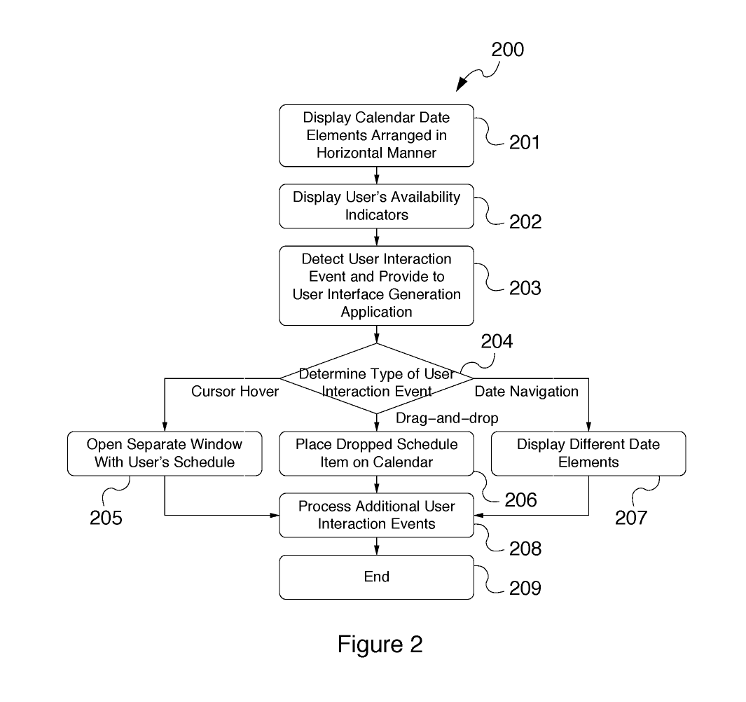

FIG. 2 illustrates an exemplary operating sequence 200 of an embodiment of the application for generating the novel calendar graphical user interface. At step 201, the user interface generation application displays the calendar date elements on the display device arranged in a horizontal manner. At step 202, the color-coded user availability indicators are displayed below the respective date elements. At step 203, the user interaction event is detected and provided to the user interface generation application. The type of user interaction event is determined in step 204. If the user interaction event is a cursor hover, then at step 205 a separate window is generated displaying user's schedule for the specific date. In one or more embodiments, the displayed window is a pop-up window. If the detected event is a drag-and-drop event, then at step 206, the dropped schedule item is placed on the calendar. In one or more embodiments, the user may be provided with a notification, using, for example, a pop-up window, that the corresponding event was successfully added. Finally, if the event is a date navigation event, then at step 207 different date elements are displayed in the generated calendar graphical user interface. Additional events are handled in step 208 and the operation terminates in step 209.

It should be noted that in one or more embodiments, the described user interface may automatically generate reminders for the users of particular tasks that require user's attention, such as an upcoming or an over-due deadline. In one or more embodiments, the described calendar user interface may be incorporated into an electronic messaging application, such as email application. In this case, email messages may act as schedule items that may be dropped on specific calendar date elements. In one or more embodiments, the aforesaid calendar interface may be used to illustrate the chronology of user's communication thread with other user(s). The color indicator described above may be used, for example, to indicate the number of communications in the particular communication thread or in the inbox in general during a specific calendar day. In the context of cloud document storage, the aforesaid calendar user interface may be used to display the chronology of file revisions or chronology of a specific project including, for example, information on when specific files were added. Moreover, in one or more embodiments, the scheduled calendar events may be recurring events, such as a weekly meeting. The recurring events may be displayed in various settings, such as when the user creates a recurring event or when the user hover the mouse over a recurring event on the calendar.

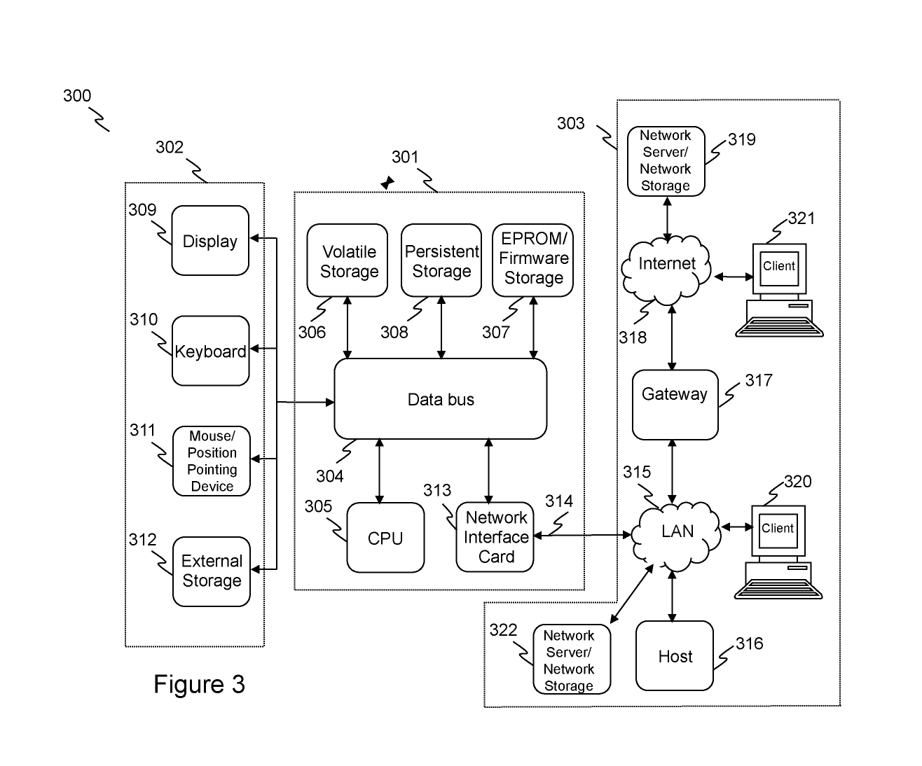

FIG. 3 is a block diagram that illustrates an embodiment of a computer system 300 upon which various embodiments of the inventive concepts described herein may be implemented. The system 300 includes a computer platform 301, peripheral devices 302 and network resources 303.

The computer platform 301 may include a data bus 304 or other communication mechanism for communicating information across and among various parts of the computer platform 301, and a processor 305 coupled with bus 304 for processing information and performing other computational and control tasks. Computer platform 301 also includes a volatile storage 306, such as a random access memory (RAM) or other dynamic storage device, coupled to bus 304 for storing various information as well as instructions to be executed by the processor 305, including the software application for automated generation of the graphical user interface incorporating a horizontally-oriented calendar described above. The volatile storage 306 also may be used for storing temporary variables or other intermediate information during execution of instructions by processor 305. Computer platform 301 may further include a read only memory (ROM or EPROM) 307 or other static storage device coupled to bus 304 for storing static information and instructions for processor 305, such as basic input-output system (BIOS), as well as various system configuration parameters. A persistent storage device 308, such as a magnetic disk, optical disk, or solid-state flash memory device is provided and coupled to bus 304 for storing information and instructions.

Computer platform 301 may be coupled via bus 304 to a touch-sensitive display 309, such as a cathode ray tube (CRT), plasma display, or a liquid crystal display (LCD), for displaying information to a system administrator or user of the computer platform 301. An input device 310, including alphanumeric and other keys, is coupled to bus 304 for communicating information and command selections to processor 305. Another type of user input device is cursor control device 311, such as a mouse, a trackball, or cursor direction keys for communicating direction information and command selections to processor 305 and for controlling cursor movement on touch-sensitive display 309. This input device typically has two degrees of freedom in two axes, a first axis (e.g., x) and a second axis (e.g., y), that allows the device to specify positions in a plane. To detect user's gestures, the display 309 may incorporate a touchscreen interface configured to detect user's tactile events and send information on the detected events to the processor 305 via the bus 304.

An external storage device 312 may be coupled to the computer platform 301 via bus 304 to provide an extra or removable storage capacity for the computer platform 301. In an embodiment of the computer system 300, the external removable storage device 312 may be used to facilitate exchange of data with other computer systems.

The invention is related to the use of computer system 300 for implementing the techniques described herein. In an embodiment, the inventive system may reside on a machine such as computer platform 301. According to one embodiment of the invention, the techniques described herein are performed by computer system 300 in response to processor 305 executing one or more sequences of one or more instructions contained in the volatile memory 306. Such instructions may be read into volatile memory 306 from another computer-readable medium, such as persistent storage device 308. Execution of the sequences of instructions contained in the volatile memory 306 causes processor 305 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 305 for execution. The computer-readable medium is just one example of a machine-readable medium, which may carry instructions for implementing any of the methods and/or techniques described herein. Such a medium may take many forms, including but not limited to, non-volatile media and volatile media. Non-volatile media includes, for example, optical or magnetic disks, such as the persistent storage device 308. Volatile media includes dynamic memory, such as volatile storage 306.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read.

Various forms of computer readable media may be involved in carrying one or more sequences of one or more instructions to processor 305 for execution. For example, the instructions may initially be carried on a magnetic disk from a remote computer. Alternatively, a remote computer can load the instructions into its dynamic memory and send the instructions over a telephone line using a modem. A modem local to computer system can receive the data on the telephone line and use an infra-red transmitter to convert the data to an infra-red signal. An infra-red detector can receive the data carried in the infra-red signal and appropriate circuitry can place the data on the data bus 304. The bus 304 carries the data to the volatile storage 306, from which processor 305 retrieves and executes the instructions. The instructions received by the volatile memory 306 may optionally be stored on persistent storage device 308 either before or after execution by processor 305. The instructions may also be downloaded into the computer platform 301 via Internet using a variety of network data communication protocols well known in the art.

The computer platform 301 also includes a communication interface, such as network interface card 313 coupled to the data bus 304. Communication interface 313 provides a two-way data communication coupling to a network link 314 that is coupled to a local network 315. For example, communication interface 313 may be an integrated services digital network (ISDN) card or a modem to provide a data communication connection to a corresponding type of telephone line. As another example, communication interface 313 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 313 sends and receives electrical, electromagnetic or optical signals that carry digital data streams representing various types of information.

Network link 314 typically provides data communication through one or more networks to other network resources. For example, network link 314 may provide a connection through local network 315 to a host computer 316, or a network storage/server 322. Additionally or alternatively, the network link 314 may connect through gateway/firewall 317 to the wide-area or global network 318, such as an Internet. Thus, the computer platform 301 can access network resources located anywhere on the Internet 318, such as a remote network storage/server 319. On the other hand, the computer platform 301 may also be accessed by clients located anywhere on the local area network 315 and/or the Internet 318. The network clients 320 and 321 may themselves be implemented based on the computer platform similar to the platform 301.

Local network 315 and the Internet 318 both use electrical, electromagnetic or optical signals that carry digital data streams. The signals through the various networks and the signals on network link 314 and through communication interface 313, which carry the digital data to and from computer platform 301, are exemplary forms of carrier waves transporting the information.

Computer platform 301 can send messages and receive data, including program code, through the variety of network(s) including Internet 318 and LAN 315, network link 315 and communication interface 313. In the Internet example, when the system 301 acts as a network server, it might transmit a requested code or data for an application program running on client(s) 320 and/or 321 through the Internet 318, gateway/firewall 317, local area network 315 and communication interface 313. Similarly, it may receive code from other network resources.

The received code may be executed by processor 305 as it is received, and/or stored in persistent or volatile storage devices 308 and 306, respectively, or other non-volatile storage for later execution.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, Objective-C, perl, shell, PHP, Java, as well as any now known or later developed programming or scripting language.

Moreover, other implementations of the invention will be apparent to those skilled in the art from consideration of the specification and practice of the invention disclosed herein. Various aspects and/or components of the described embodiments may be used singly or in any combination in the systems and methods for automated generation of the graphical user interface incorporating a horizontally-oriented calendar described above. It is intended that the specification and examples be considered as exemplary only, with a true scope and spirit of the invention being indicated by the following claims.

What is claimed is:

1. A computer-implemented method for generating a graphical user interface, the method being performed in connection with a computerized system comprising a processor, a memory and a display device, the method comprising:
a. generating a graphical user interface on the display device, the graphical user interface comprising a calendar portion, the calendar portion comprising a plurality of calendar date elements, wherein the plurality of calendar date elements are horizontally arranged on the display device and wherein at least some of the calendar date elements comprise a user availability indicator indicating an availability of a user during a corresponding day;
b. receiving information on a user interaction event in connection with the calendar portion of the user interface;
c. if the received information indicates that the user interaction event is a cursor hover event performed in connection with a first calendar date element of the plurality of calendar date elements, displaying information regarding the first calendar date element; and
d. if the received information indicates that the user interaction event is a drag-and-drop event performed in connection with a second calendar date element of the plurality of calendar date elements and a schedule item, placing the schedule item on the user's schedule during a date corresponding to the second calendar date element.

2. The computer-implemented method of claim 1, wherein the information regarding the first calendar date element is displayed is a pop-up window.

3. The computer-implemented method of claim 1, wherein the user availability indicator is color-coded based on the availability of the user during the corresponding day.

4. The computer-implemented method of claim 1, wherein the user availability indicator is color-coded with a color selected from a group consisting of: green, yellow and red colors.

5. The computer-implemented method of claim 1, wherein the calendar portion further comprises at least one date navigational element and wherein upon user's interaction with the at least one date navigational element, a second plurality of calendar date element is displayed.

6. The computer-implemented method of claim 1, wherein the calendar portion is positioned at the bottom of the graphical user interface.

7. The computer-implemented method of claim 1, wherein if the received information indicates that the user interaction event is a mouse click event performed in connection with a third calendar date element of the plurality of calendar date elements, displaying information regarding the third calendar date element in a main window of the graphical user interface.

8. A non-transitory computer-readable medium embodying a set of computer-readable instructions, which, when executed in connection with a computerized system comprising a processor, a memory and a display device, cause the computerized system to perform a method for generating a graphical user interface, the method comprising:
a. generating a graphical user interface on the display device, the graphical user interface comprising a calendar portion, the calendar portion comprising a plurality of calendar date elements, wherein the plurality of calendar date elements are horizontally arranged on the display device and wherein at least some of the calendar date elements comprise a user availability indicator indicating an availability of a user during a corresponding day;
b. receiving information on a user interaction event in connection with the calendar portion of the user interface;
c. if the received information indicates that the user interaction event is a cursor hover event performed in connection with a first calendar date element of the plurality of calendar date elements, displaying information regarding the first calendar date element; and
d. if the received information indicates that the user interaction event is a drag-and-drop event performed in connection with a second calendar date element of the plurality of calendar date elements and a schedule item, placing the schedule item on the user's schedule during a date corresponding to the second calendar date element.

9. The non-transitory computer-readable medium of claim 8, wherein the information regarding the first calendar date element is displayed is a pop-up window.

10. The non-transitory computer-readable medium of claim 8, wherein the user availability indicator is color-coded based on the availability of the user during the corresponding day.

11. The non-transitory computer-readable medium of claim 8, wherein the user availability indicator is color-coded with a color selected from a group consisting of: green, yellow and red colors.

12. The non-transitory computer-readable medium of claim 8, wherein the calendar portion further comprises at least one date navigational element and wherein upon user's interaction with the at least one date navigational element, a second plurality of calendar date element is displayed.

13. The non-transitory computer-readable medium of claim 8, wherein the calendar portion is positioned at the bottom of the graphical user interface.

14. The non-transitory computer-readable medium of claim 8, wherein if the received information indicates that the user interaction event is a mouse click event performed in connection with a third calendar date element of the plurality of calendar date elements, displaying information regarding the third calendar date element in a main window of the graphical user interface.

15. A computerized system comprising a processor, a memory and a display device, the memory storing a set of computer-readable instructions, which, when executed by the processor cause the computerized system to perform a method for generating a graphical user interface, the method comprising:
a. generating a graphical user interface on the display device, the graphical user interface comprising a calendar portion, the calendar portion comprising a plurality of calendar date elements, wherein the plurality of calendar date elements are horizontally arranged on the display device and wherein at least some of the calendar date elements comprise a user availability indicator indicating an availability of a user during a corresponding day;
b. receiving information on a user interaction event in connection with the calendar portion of the user interface;
c. if the received information indicates that the user interaction event is a cursor hover event performed in connection with a first calendar date element of the plurality of calendar date elements, displaying information regarding the first calendar date element; and
d. if the received information indicates that the user interaction event is a drag-and-drop event performed in connection with a second calendar date element of the plurality of calendar date elements and a schedule item, placing the schedule item on the user's schedule during a date corresponding to the second calendar date element.

16. The computerized system of claim 15, wherein the information regarding the first calendar date element is displayed is a pop-up window.

17. The computerized system of claim 15, wherein the user availability indicator is color-coded based on the availability of the user during the corresponding day.

18. The computerized system of claim 15, wherein the user availability indicator is color-coded with a color selected from a group consisting of: green, yellow and red colors.

19. The computerized system of claim 15, wherein the calendar portion further comprises at least one date navigational element and wherein upon user's interaction with the at least one date navigational element, a second plurality of calendar date element is displayed.

20. The computerized system of claim 15, wherein the calendar portion is positioned at the bottom of the graphical user interface.

21. The computerized system of claim 15, wherein if the received information indicates that the user interaction event is a mouse click event performed in connection with a third calendar date element of the plurality of calendar date elements, displaying information regarding the third calendar date element in a main window of the graphical user interface.
